(19) United States
(12) Patent Application Publication
(10) Pub. No.: US 2025/0050855 A1
(43) Pub. Date: Feb. 13, 2025

(54) BRAKE SYSTEM FOR TRACTOR-TRAILER

(71) Applicant: Kodiak Robotics, Inc., Mountain View, CA (US)

(72) Inventors: Court Scott HINRICHER, Pacifica, CA (US); Muzaffer Arda BUYUKSAN, Palo Alto, CA (US)

(21) Appl. No.: 18/446,202

(22) Filed: Aug. 8, 2023

(51) Int. Cl. B60T 13/26; B60T 13/68

(52) U.S. Cl. CPC B60T 13/26; B60T 13/68

(57) ABSTRACT

A brake system for an autonomous tractor-trailer includes a first brake valve configured to allow pressurized air to flow to first tractor brakes and trailer brakes, a second brake valve configured to allow pressurized air to flow to second tractor brakes, and a third brake valve configured to allow pressurized air to flow to the trailer brakes, wherein the third brake valve is configured to be actuated before the first brake valve and the second brake valve.

### CROSS-REFERENCE TO RELATED APPLICATIONS

This application is related to Attorney Docket No. 143805.580802, filed Aug. 8, 2023, the contents of which are incorporated by reference in its entirety.

### TECHNICAL FIELD

The present disclosure relates to a brake system for a tractor-trailer.

### BACKGROUND

Vehicles may be operated autonomous or semi-autonomously. Brake systems and methods may be employed to control operation of the vehicle.

### BRIEF SUMMARY

A brake system for an autonomous tractor-trailer includes a first brake valve configured to allow pressurized air to flow to first tractor brakes and trailer brakes, a second brake valve configured to allow pressurized air to flow to second tractor brakes, and a third brake valve configured to allow pressurized air to flow to the trailer brakes, wherein the third brake valve is configured to be actuated before the first brake valve and the second brake valve.

An autonomous tractor-trailer including a tractor, a trailer coupled to the tractor, and a brake system configured to stop the tractor and the trailer. The brake system including a first valve system configured to apply brakes to the tractor and the trailer, and a second valve system configured to apply brakes to the trailer, wherein the second valve system is actuated prior to the first valve system.

A method of braking a tractor-trailer driven autonomously, the method including sensing, autonomously, a braking event, the braking event being indicative of a requirement for braking the tractor-trailer and actuating a trailer brake valve of a trailer of the tractor-trailer to apply trailer brakes in response to the sensing of the braking event, wherein the trailer brakes are applied prior to actuating a tractor brake valve of a tractor of the tractor-trailer to apply tractor brakes and to apply trailer brakes.

A method of braking a tractor-trailer includes determining surface conditions of a road, determining, based on the surface condition, a braking operation of a trailer brake valve, and actuating the braking operation of the trailer brake valve prior to actuating a tractor brake valve.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a perspective view of a tractor-trailer, according to an embodiment of the present disclosure.

FIG. 2 illustrates a perspective view of another tractor-trailer, according to an embodiment of the present disclosure.

FIG. 3 illustrates a schematic of a brake system for a tractor-trailer, according to an embodiment of the present disclosure.

FIG. 4 illustrates a schematic of another brake system for a tractor-trailer, according to an embodiment of the present disclosure.

FIG. 5 illustrates a sensor system that may be employed with the brake system of FIG. 3 or FIG. 4, according to an embodiment of the present disclosure.

FIG. 6 illustrates a method for braking a tractor-trailer with the brake system of FIG. 4, according to an embodiment of the present disclosure.

FIG. 7 illustrates a method for braking a tractor-trailer with the brake system of FIG. 3, according to an embodiment of the present disclosure.

FIG. 8 illustrates a computer system that may carry out the methods of FIG. 6 or FIG. 7, according to an embodiment of the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “rearward” refer to relative positions of a vehicle. For example, forward refers to a position closer to front hood, front bumper, or front fender of the vehicle and rearward refers to a position closer to a rear bumper, rear trunk, or trailer of the vehicle.

The terms “upper,” “lower,” “left,” and “right” refer to relative positions of a sensor pod with respect to a ground surface, as viewed from a position forward of the sensor pod. For example, “upper” refers to a position vertically above a “lower” position. For example, “left” refers to a position laterally to the left of a “right” position.

The term “side” as used herein may refer to a surface, wall, edge, border, boundary, etc., or simply to a general position or location with respect to the described component (e.g., not referring to any physical component).

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values and/or endpoints defining range(s) of values.

Autonomous vehicles require a vehicle platform with by-wire steering, braking, and throttle. A high reliability braking system is required to ensure proper stoppage of the autonomous vehicle. Therefore, the present disclosure provides a brake system that employs three brake valves, relay valves, and a tractor protection valve described herein. Two control engines are also included in the brake system to allow an electrically controlled brake system. The brake system may be installed in parallel with a mechanically controlled brake system.

The brake system of the present disclosure provides a system for stopping an autonomous or semi-autonomous tractor-trailer. The brake system of the present disclosure provides a separately and independently controlled trailer brake valve for separately and independently controlling the trailer brakes as compared to the tractor brakes. The trailer brake valve, referred to herein as the third brake valve, provides for direct timing and pressure control of trailer braking.

The brake system of the present disclosure provides several advantages. First, the brake system of the present disclosure provides precise braking control. The brake system having three separate brake valves allow precise control of brake application timing and brake pressure between the tractor brakes (both forward and rear) and the trailer brakes. The brake timing can be adjusted based on current, real-time traction/road conditions. Furthermore, the tractor protection valve ensures that the trailer always receives the highest brake pressure even in the event of a single point failure.

Another advantage of the brake system of the present disclosure is the ability to provide jack-knife mitigation for the trailer. If the vehicle controller recognizes the initiation of a jack-knife event, the three valve system provides the vehicle controller the ability to remove/reduce brake pressure from the tractor while still providing brake pressure to the trailer. This mitigation will help pull the trailer back in line with the tractor.

An additional advantage of the brake system of the present disclosure is redundancy by way of tertiary brake control. That is, even if there is failure of one or two of the brake valves, the third is still available to slow down the vehicle.

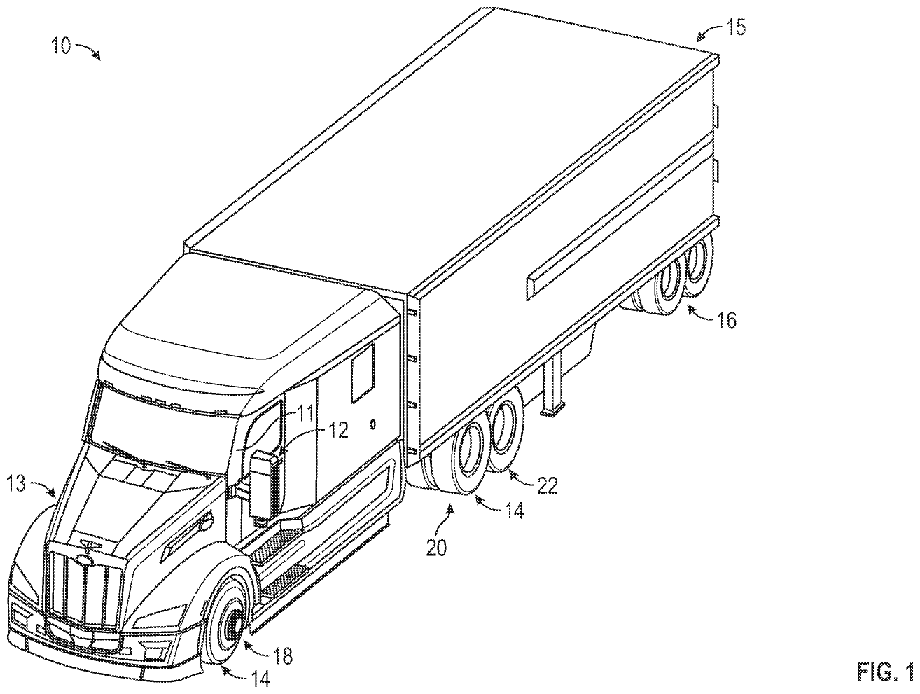

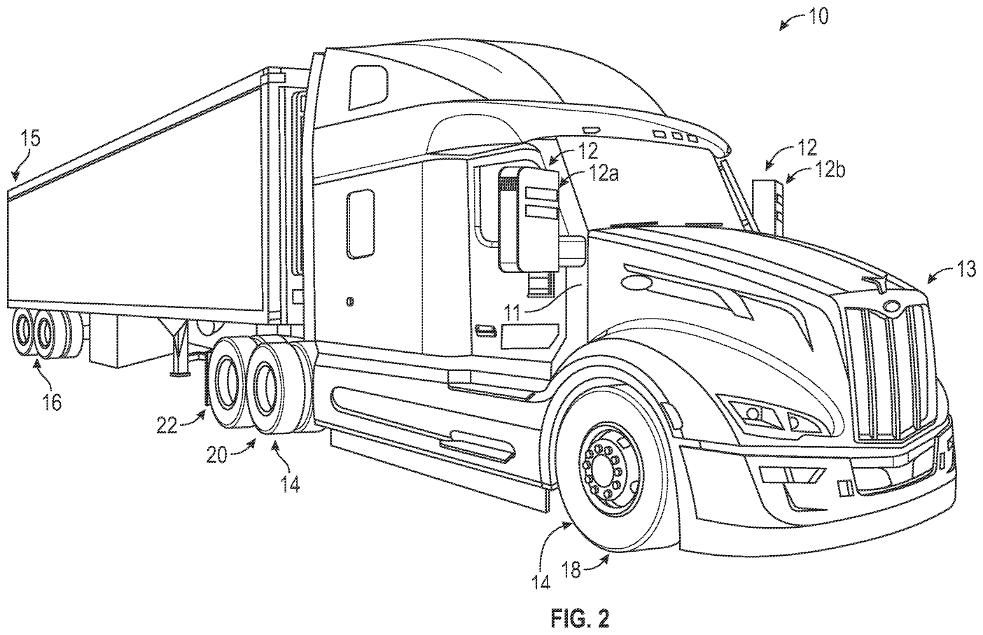

FIGS. 1 and 2 illustrate a vehicle 10 having a sensor pod 12. Although a single sensor pod 12 is illustrated in FIG. 1 and two sensor pods 12 are illustrated in FIG. 2 (e.g., a passenger side sensor pod 12a and a driver side sensor pod 12b), more or fewer may be provided. In the context of this application, the vehicle 10 is referred to as a tractor-trailer 10 having a cab 13, also referred to herein as a tractor 13, and a trailer 15. The vehicle 10, however, may be any motor vehicle that includes a hitched trailer or camper connected to a rear side of the vehicle. The tractor-trailer 10 includes forward wheels 14 on the cab 13 and rear wheels 16, or trailer wheels 16, on the trailer 15. The forward wheels include three groupings of wheels, a first group of wheels 18, a second group of wheels 20, and a third group of wheels 22, though more or fewer may be provided. The rear wheels 16 includes a single group of wheels, though more or fewer may be provided. As appreciated from the two perspective views of FIGS. 1 and 2, the wheels are present on both sides of the tractor-trailer 10.

With continued reference to FIGS. 1 and 2, the sensor pod 12 may be a side mirror assembly mounted to the vehicle 10. The sensor pod 12 may assist in navigation of the vehicle 10. In some examples, the sensor pod 12 may assist in navigation in a manner that results in the vehicle 10 being autonomous, self-driving, semi-autonomous, non-autonomous with assisted navigation, etc., or combinations thereof. In this regard, the sensor pod 12 may include components, such as, but not limited to, sensors and mirrors, which may be useful for the operation of the vehicle 10, or any combination thereof. The vehicle 10 may use (via a processor or controller) data collected by the sensor pod 12 to navigate or to assist in navigating the vehicle 10 and to control the speed, direction, braking, and other functions of the vehicle 10. By way of example, the sensor pod 12 may be, or may include the sensors, cameras, mirrors, and associated components of, the sensor pod described in International Patent Application Publication No. WO 2020/180707, the contents of which are herein incorporated by reference in their entirety. Although illustrated as mounted to an A-pillar 11 of the frame of the vehicle 10 near the driver side and/or passenger side doors, the sensor pod 12 may be mounted to other locations on the vehicle 10, such as, for example, but not limited to, driver side and/or passenger side doors or other locations on the frame of the vehicle 10. The mounting site of the sensor pod 12 may preferably use existing mounting points for the vehicle 10 or may mount with appropriate hardware to the truck structure. The sensor pod 12 may be connected or coupled to the vehicle 10 with a connecting assembly. The sensor pod 12 and/or the connecting assembly may be the same as the sensor pod and connecting assembly described in U.S. application Ser. No. 17/826,000, the contents of which are herein incorporated by reference in their entirety.

As described in International Patent Application Publication No. WO 2020/180707, the sensor pod 12 includes a variety of sensors to monitor the surroundings of the vehicle 10. The sensors may include, for example, but not limited to, one or more cameras, one or more lidars, one or more radars, and one or more inertial measurement units (IMUs). The combined data from the sensors may be used by a processor to autonomously (or semi-autonomously) navigate or to assist a driver in navigating the roadway in a variety of light conditions, weather conditions, traffic conditions, load conditions, road conditions, etc. The sensors, mirrors, and other features of the sensor pod 12 are configured and oriented to provide a predetermined field of view and to provide reliable, accurate, and high-quality data for autonomous and semi-autonomous driving. The specific sensor placement and the rigidity of the connecting assembly and support structure enable a sufficient field of view while reducing vibrational disturbances and allowing a high object detection rate and high-quality positional data.

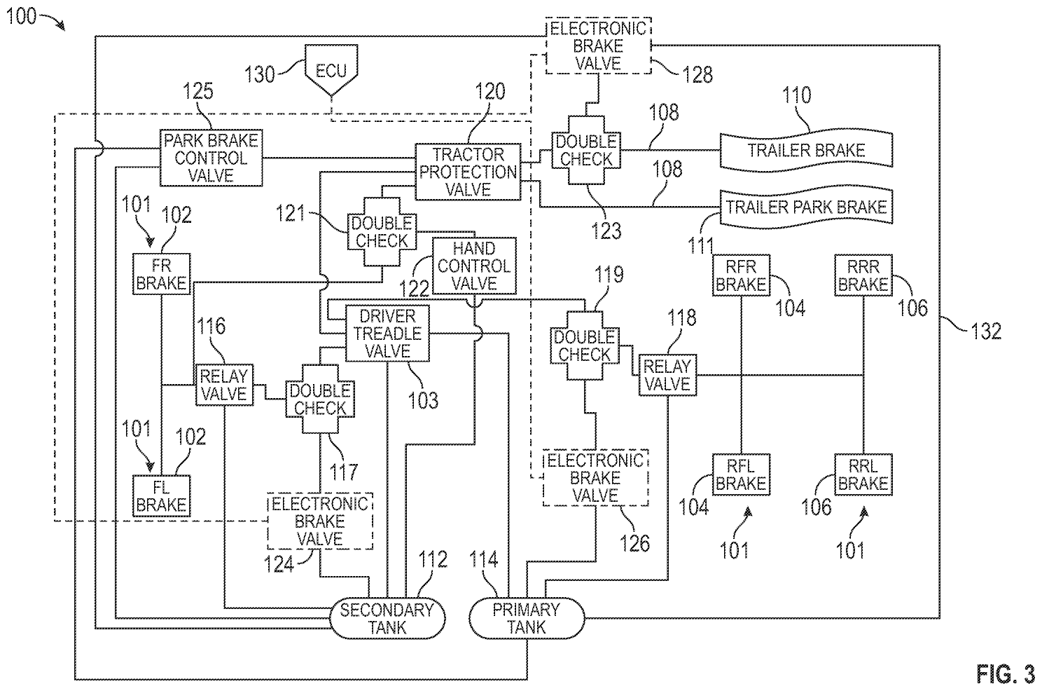

FIG. 3 illustrates a schematic of a brake system 100 that may be employed with the vehicle 10 of FIG. 1 or FIG. 2. The brake system 100 of FIG. 3 includes tractor brakes 101 and trailer brakes 110. The tractor brakes 101 include first brakes 102, that may be brakes for the first group of wheels 18 (FIG. 1), second brakes 104 that may be brakes for the second group of wheels 20 (FIG. 1), and third brakes 106 that may be brakes for the third group of wheels 22 (FIG. 1). The hoses 108 are for coupling the tractor 13 to the trailer 15 (FIG. 1) to enable control of the trailer brakes 110 (illustrated schematically) of the rear wheels 16 (FIG. 1).

The brake system 100 includes a first reservoir 112 for providing pneumatic pressure to the first brakes 102 and the trailer brakes 110, also referred to herein as fourth brakes 110, and a second reservoir 114 for providing pressure (e.g., air pressure) to the second brakes 104, the third brakes 106, and the trailer brakes 110. The first reservoir 112 and the second reservoir 114 may be supplied by an air compressor (not illustrated), and, optionally, an air dryer (not illustrated). The brake system 100 includes a first relay valve 116 and a first double check valve 117 for providing pressure from the reservoirs to the first brakes 102 of the tractor brakes 101. The brake system 100 includes a second relay valve 118 and a second double check valve 119 for providing pressure from the reservoirs to the second brakes 104 and third brakes 106 of the tractor brakes 101. The brake system 100 includes a manual valve 120, also referred to as a tractor protection valve 120, and a third double check valve 121 for providing pressure from the reservoirs to the trailer brakes 110. The brake system 100 includes a fourth double check valve 123 for providing pressure from the reservoirs to the trailer brakes 110. The brake system 100 may also include a control valve 125 for actuating a trailer parking brake 111.

During operation, the brake system 100 allows for stoppage of a vehicle. When the brake system 100 is actuated, the forward relay valve 116 and the rear relay valve 118 are opened, and pressure is transmitted through the pressure lines, and through the respective double check valves, from the first reservoir 112 and the second reservoir 114 to the tractor brakes 101 and to the trailer brakes 110 by way of the tractor protection valve 120. The pressure applies the brakes 102, 104, and 106 to stop movement of the tractor 13 (FIG. 1). To stop movement of the trailer 15 (FIG. 1), the brake system 100 provides the pressure from the reservoirs through the tractor protection valve 120 to the trailer brakes 110 of the trailer 15 (FIG. 1). This actuation, therefore, stops both the tractor 13 and the trailer 15 of the tractor-trailer 10. The brake system 100 may be actuated by a manual valve 103, the treadle valve, associated with manual brake pedals in the vehicle.

The brake system 100 may, optionally, include a hand control valve 122. The hand control valve 122 is a manual valve that allows for additional pressure to be supplied to the trailer brakes 110 of the trailer 15 separate from the pressure applied through the tractor protection valve 120. The hand control valve 122 can be activated when an operator in the cab 13 of the tractor-trailer 10 is concerned that the trailer 15 has uncontrolled movement (e.g., skidding, jack-knifing, etc.) or based on current or anticipated environmental conditions (e.g., icy or slick roads). That is, the user has control over when the hand control valve 122 is actuated to apply the brakes to the trailer brakes 110. The hand control valve 122 is pulled by the operator, which then provides braking to the trailer brakes 110 and operates to stop movement of the trailer 15. Thus, the hand control valve 122 provides a fail-safe for the brake system 100 by applying separate or additional brake pressure to the brakes of the trailer 15. Such a fail-safe may prevent or limit the occurrence of catastrophic events with the trailer 15.

In order to provide an autonomous or semi-autonomous vehicle (e.g., any vehicle that does not have an operator to operate the manual valves 103, 122) with braking capabilities, the brake system 100 also includes a first brake valve 124, a second brake valve 126, a third brake valve 128, and a controller 130. Each of the brake valves 124, 126, and 128 may be electronically actuated by a controller (e.g., controller 130). Although the controller 130 is illustrated in communication with the brake valves 124, 126, and 128, the controller 130 may also be in communication with any of the other components of the systems illustrated in FIGS. 3 to 5. The first brake valve 124 and the second brake valve 126 may operate in the same manner as the manual valve 103, to apply the tractor brakes 101 and the trailer brakes 110 in a manner similar to the aforementioned described manual actuation. Instead of application of a brake pedal by a user, however, the controller 130 may be actuated by a remote user and/or the vehicle itself (e.g., based on the current environment as detected by the sensor pod 12 and associated vehicle computer system/controller and/or based on the calculated driving plan provided to the vehicle) to actuate braking of the tractor-trailer 10.

The third brake valve 128 provides the functions of the hand control valve 122 to the tractor-trailer 10. That is, the third brake valve 128 is controllable to provide additional or separate braking (apart from the pressure applied through the tractor protection valve 120) to the trailer brakes 110. The brake system 100 also includes a separate pressure line 132 from the second reservoir 114 directly to the trailer brakes 110. When the third brake valve 128 is actuated, pressure is admitted from the pressure line 132 to the trailer brakes 110. Thus, the third brake valve 128 allows separate control of the trailer brakes 110 apart from the control provided through the tractor protection valve 120.

More specifically, the third brake valve 128 may allow for braking to be provided by the trailer brakes 110 separately from the braking applied by the tractor brakes 101 and separately from the braking applied to the trailer brakes 110 through the tractor protection valve 120. The timing of the application of pressure to the trailer brakes 110 (e.g., timing of actuation of third brake valve 128) may be selected in relation to the timing of application of pressure to the tractor brakes 101. For example, in situations where icy or slick road conditions are expected or sensed, the third brake valve 128 may be actuated before the first brake valve 124 and the second brake valve 126. In this manner, the braking provided by the third brake valve 128 allows for the trailer brakes 110 to be actuated prior to the tractor brakes 101. This advanced braking allows the trailer 15 to remain straight with respect to (e.g., longitudinally aligned with) the tractor 13, avoiding dangerous swerving or jack-knifing. The difference in timing between actuation of the third brake valve 128 and the first and second brake valves 124, 126, may be on the order of milliseconds, for examples, between two hundred and three hundred milliseconds. This timing is only an example, and the particular timing of advanced braking may be determined for each application of the braking based on the particular environmental conditions at the time of braking.

Therefore, the third brake valve 128, with the dedicated, separate pressure line 132, allows for the trailer brakes 110 to be applied independently of the tractor brakes 101. The third brake valve 128 can be dynamically controlled. By stopping the trailer brakes 110 independently, greater control over the trailer is achieved, which can avoid undesired motion of the trailer. For example, as mentioned, the trailer brakes 110 may be applied prior to the tractor brakes 101. This may allow for the trailer 15 to begin stopping prior to the tractor 13, which assists in maintaining the trailer behind and aligned with the tractor, avoiding jack-knifing or angled movement of the trailer 15 with respect to the tractor 13. In another example, the separate control of the third brake valve 128 may allow for different levels of pressure application to the tractor brakes 101 and the trailer brakes 110. That is, for example, more pressure may be applied to the trailer brakes 110 through the third brake valve 128, while dropping or lowering the pressure applied to the tractor brakes 101, allowing direct control of the amount of braking applied to each of the tractor brakes 101 and the trailer brakes 110. Such a situation may be desirable when, for example, the vehicle 10 is sliding on ice, by increasing the braking of the trailer and reducing the braking of the tractor, the sliding may be mitigated or stopped.

The third brake valve 128 may be actuated by a controller. The controller may be programmed with a predetermined vehicle travel plan. If the vehicle is detected to be out of alignment with the vehicle travel plan, the controller can take action. The action may include, amongst other actions, control of the brakes (e.g., by way of the aforementioned brake valves), steering, and/or throttle. For example, the controller may control the third brake valve 128 to increase pressure to the trailer brakes 110. As noted earlier, this may stop the trailer prior to stopping the tractor. As also discussed, the controller may also control the first brake valve 124 and second brake valve 126 (e.g., to reduce pressure, while increasing pressure to the third brake valve 128). Detection of the vehicle to not be on the planned vehicle travel plan may occur by a variety of manners, for example, but not limited to, detection by the sensor pods 12, detection by sensors within the vehicle that detect the position or relative position of the tractor and trailer, and/or sensors that detect the position of the vehicle with respect to the predetermined vehicle travel plan. Therefore, control of the third brake valve 128 may be selected based on the particular timing, braking, and pressure needs of the controller according to the predetermined vehicle travel plan.

Accordingly, the brake system 100 of the present disclosure allows for control of the trailer brakes independently of the tractor brakes. In this manner, the trailer brakes can be applied at a particular time based on the particular conditions at the time of actuation of the brake valve. For example, when road surface conditions are not favorable, e.g., low traction, slippery, icy, etc., the trailer brakes may be actuated in advance of the tractor brakes to ensure stoppage of the vehicle without jack-knifing (or with minimal jack-knifing) of the trailer. When, however, road surface conditions are favorable such that traction is normal or standard for that particular road or highway, the trailer brakes may still be applied earlier than the tractor brakes, but not as early as in poor road surface conditions. This is due to the fact that the risk of jack-knifing is lower when the surface road conditions and available traction to the vehicle are higher, thus resulting in more even braking pressure at each wheel, which practically exhibits as later actuation of the trailer brake valve or less pressure applied to the trailer brakes.

Thus, the brake system 100 allows for manual braking, autonomous or semi-autonomous braking, or both. That is, in some examples, the manual valve 103 and the hand control valve 122 may be optional and may be omitted. In lieu of these features, the vehicle may be provided electronically controlled brake valves (e.g., the controller 130 and the brake valves 124, 126, and 128). In some examples, both the manual and electronic brake valves are provided such that the vehicle may be operated both manually and autonomously or semi-autonomously.

Each of the brake valves 124, 126, and 128 are brake actuator valves. The valves may be electronically controlled air valves. Any or all of the valves described herein may be one-way valves to control the direction of pressure through the lines between the reservoirs and brakes.

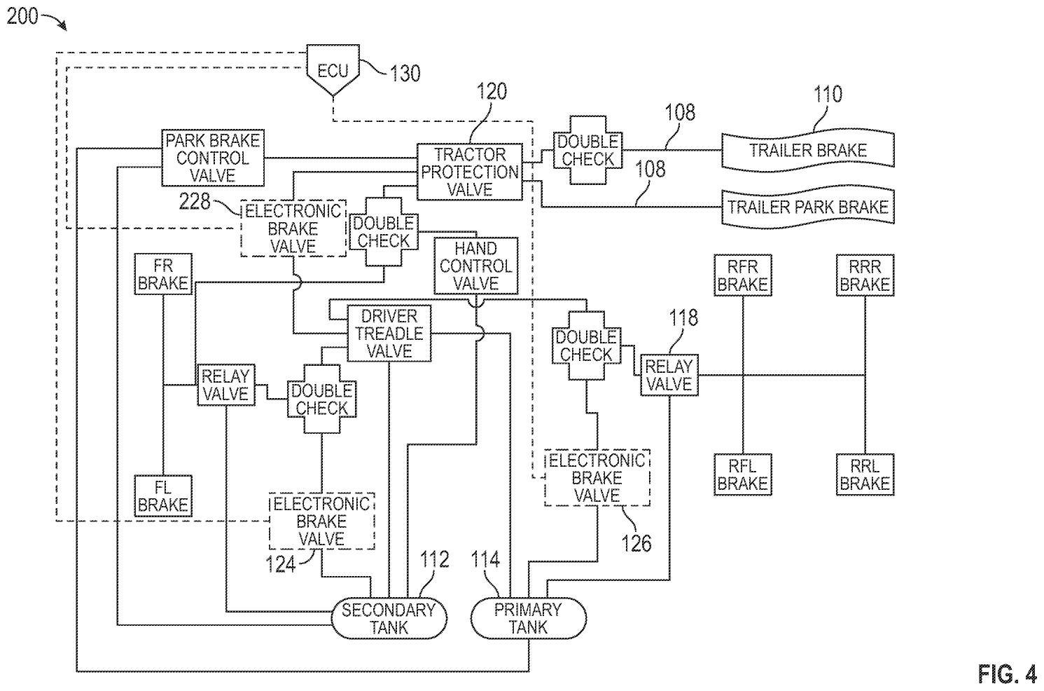

FIG. 4 illustrates a brake system 200 that may be similar to the brake system 100, with the exception of the location of the third brake valve 228. All of the variations described with respect to brake system 100 may be applied to the brake system 200. Accordingly, reference numerals related to FIG. 3 are not reproduced in FIG. 4, but like illustrated components should understood to be the same as illustrated in FIG. 3. In the embodiment of FIG. 3, the third brake valve 128 is located behind or downstream of the tractor protection valve 120. In the embodiment of FIG. 4, the third brake valve 228 is located ahead of or upstream of the tractor protection valve 120.

Referring to both FIGS. 3 and 4, the tractor protection valve 120 is provided to ensure pressure is not sent through the pressure lines 108 downstream of the tractor protection valve 120 when no trailer is attached. As shown, there are two lines or hoses 108 downstream of the tractor protection valve 120, when pressure is supplied to the first of those lines (e.g., for suspension, etc.) it is an indication to the tractor protection valve 120 that a trailer is attached. If no pressure is in that first line, then no pressure will be permitted to be admitted to the second line, since no trailer is detected as being attached.

Therefore, in the example of FIG. 3, where the third brake valve 128 is located downstream of the tractor protection valve 120, pressure can be sent through the pressure line 132 and the third brake valve 128 if no trailer is attached, resulting in air exiting the hoses 108 and into the environment. If a trailer is attached, the pressure is supplied through one of the hoses 108 to the trailer brakes 110. With the third brake valve 128 in this location, the controller is configured to recognize the presence of a trailer to decide when to command trailer braking. In the first condition, where the controller does not recognize a trailer attached, the brake system 100 actuates the first brake valve 124 and the second brake valve 126, only. The third brake valve 128 is not actuated, thus avoiding the supplying of pressure through the hose 108 that is not connected to a trailer. In the second condition, where the controller does recognize a trailer attached, the brake system 100 actuates all three valves in the manner described herein.

On the other hand, when the third brake valve 228 is located upstream of the tractor protection valve 120, as in FIG. 4, the brake system 200 can operate in the three valve actuation mode even when a trailer is not attached. This is due to the tractor protection valve 120 preventing air pressure from exiting the hoses 108 without a trailer attached.

Stated another way, the brake system 100 of FIG. 1 and the brake system 200 of FIG. 2 provide the first brake valve 124 to control braking of the front two wheels 18 (FIG. 2) and the second brake valve 126 to control the braking of the wheels 20 and 22 (FIG. 2). The brake system 100 provides the third brake valve 128 and the brake system 200 provides the third brake valve 228 to provide redundancy and improved actuation control of braking of the trailer wheels 16 (FIG. 2). The brake valves are coupled to the vehicle controller via a CAN network.

Although three brake valves 124, 126, and 128 are depicted, more may be provided. In the case where more than three brake valves are provided, the additional brake valves may provide redundancy for the system. That is, in the situation where there is a failure, a redundant brake valve may allow for continued actuation of the respective brake.

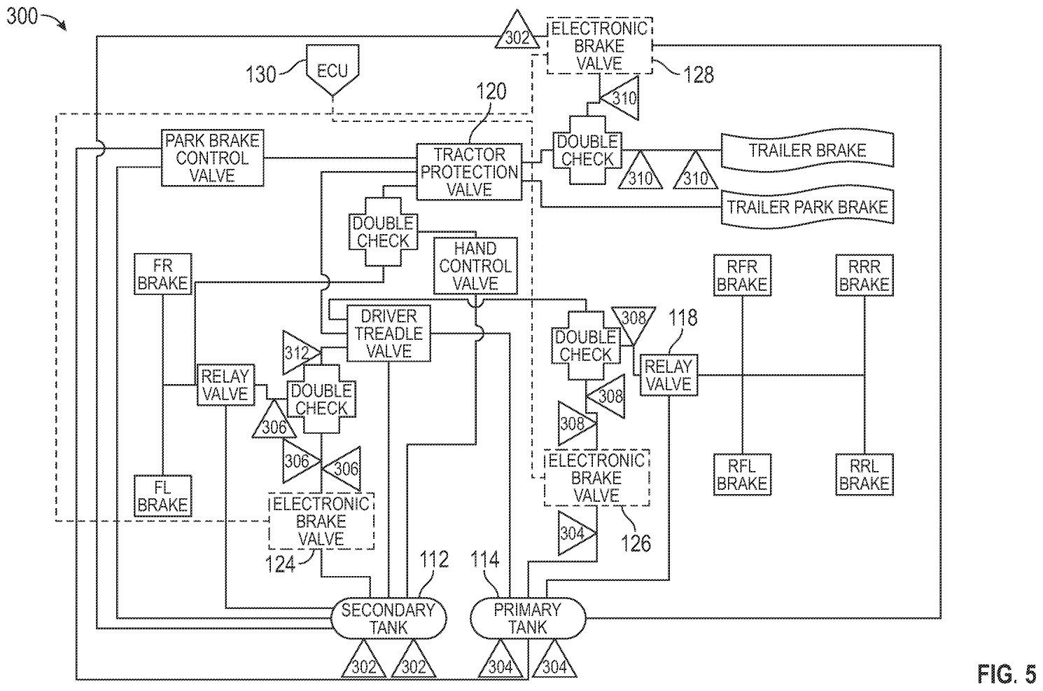

FIG. 5 illustrates a sensor system 300 that may be employed with the brake system 100 or the brake system 200. Accordingly, reference numerals related to FIGS. 3 and 4 are not reproduced in FIG. 5, but like illustrated components should understood to be the same as illustrated in FIGS. 3 and 4.

As shown in FIG. 5, the sensor system 300 includes a plurality of pressure sensors. The pressure sensors may be located at the first reservoir 112 and the second reservoir 114, and at the first brake valve 124, second brake valve 126, and third brake valve 128. The sensor system 300 provides a fault protection for the brake system 100 and the brake system 200. By monitoring the pressure, the sensor system 300 allows for a reliable indication of the pressure in the reservoirs and at each valve, thus allowing monitoring, diagnosing, or detecting of any faults that may occur within the system.

As illustrated in FIG. 5, each of the reservoirs and the brake valves are provided with multiple pressure sensors to monitor a pressure at the respective component. For example, the first reservoir 112 is associated with pressure sensors 302, the second reservoir 114 is associated with pressure sensors 304, the first brake valve 124 is associated with pressure sensors 306, the second brake valve 126 is associated with pressure sensors 308, and the third brake valve 128 is associated with pressure sensors 310. The manual valve 103 may optionally be provided with a pressure sensor 312.

The arrangement of the pressure sensors is such that each brake valve 124, 126, 128 is provided with three pressure sensors upstream of the brake valve and three pressure sensors downstream of brake valve. As illustrated, each of the aforementioned components may be include three pressure sensors, however, more may be provided. The pressure sensors for each component operate in a voting system. For example, if two of the pressure sensors 302 indicate a first pressure and the third of the pressure sensors 302 indicates a second pressure, different from the first, the sensor system 300 may recognize the value of the first two pressure sensors to be an accurate indication of the pressure within the first reservoir 112. By including multiple pressure sensors that operate with a voting system, reliability is built into the system to ensure accurate monitoring of the pressure within the brake system 100. An accurate indication of pressure allows for accurate monitoring of the brake system 100 (e.g., by allowing detection of pressures out of a predetermined range). In the context of this disclosure, the term accurate refers to an indication of pressure which is more likely than not to be a correct indication of the actual pressure within the respective monitored component. This is accomplished, as discussed above, with a voting system that results in a pressure that is more likely than not to be a correct indication of the pressure within the respective monitored component.

Only one pressure sensor 312 may be provided at the manual valve 103, since when the vehicle is operated by a human operator, the human operator may have personal experience with the fault such that their knowledge can be used to determine fault in the system. In that situation, reliability of the pressure sensor 312 is not required since the human operator can provide the necessary back up to confirm if a fault is present in the brake system.

In both brake system 100 of FIG. 3 and brake system 200 of FIG. 4, if there is a failure in the third brake valve 128, 228, braking is still applied to the trailer brakes 110 through the tractor protection valve 120. Thus, even with a single point failure at the third brake valve, braking of the trailer occurs.

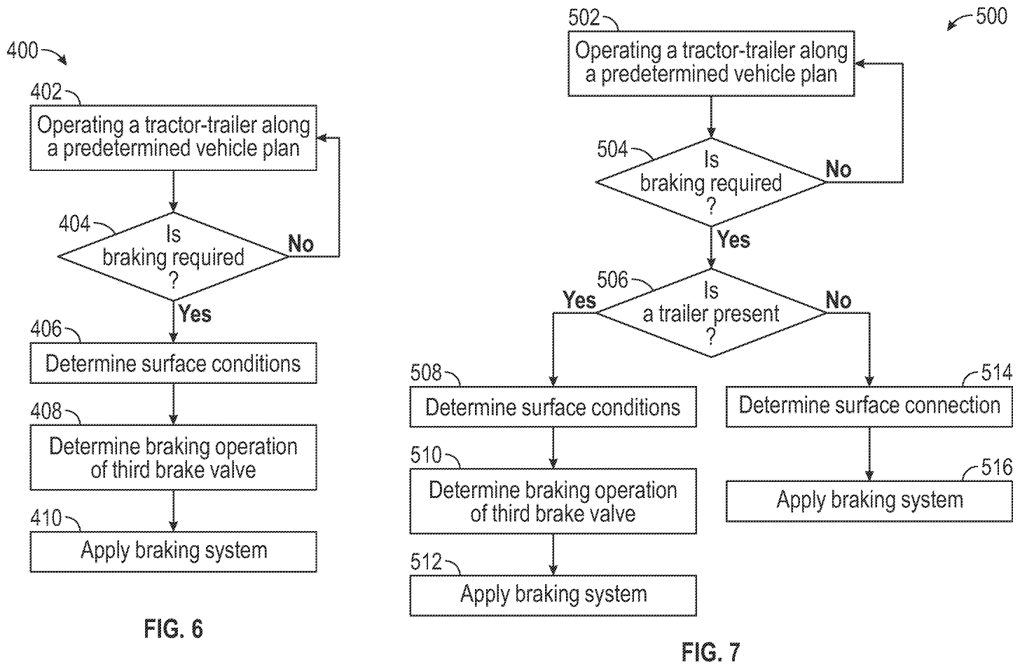

FIG. 6 illustrates an exemplary method 400 of operating a tractor-trailer having the brake system 200 of FIG. 4. During operation, the tractor-trailer is operated, at step 402, by the vehicle controller according to a predetermined vehicle plan set by the planner. At step 404, autonomous sensing of a braking event occurs. That is, the vehicle controller determines if stoppage of the tractor-trailer is required according to the vehicle plan. If no, the vehicle continues to operate on the predetermined vehicle plan. If yes, the vehicle controller than determines surface conditions at step 406. At step 408, based on the determination of step 406, the vehicle controller determines the operation of the third brake valve. That is, how much pressure should be applied to the trailer brakes and how far in advance should the pressure be applied to the trailer brakes in advance of the tractor brakes. Once these determinations are made, the braking system is actuated at step 410 and the vehicle then comes to a stop.

FIG. 7 illustrates an exemplary method 500 of operating a tractor-trailer having the brake system 100 of FIG. 3. The operation of the tractor-trailer may be the same as the method 400 of FIG. 6, however, since the third brake valve 128 is located downstream of the tractor protection valve 120, the method 500 includes additional steps to detect whether a trailer is coupled to the tractor. Accordingly, the tractor-trailer is operated, at step 502, by the vehicle controller according to a predetermined vehicle plan set by the planner. At step 504, the vehicle controller determines if stoppage of the tractor-trailer is required according to the vehicle plan. If no, the vehicle continues to operate on the predetermined vehicle plan. If yes, the vehicle controller determines or evaluates if the trailer is coupled to the tractor at step 506. Importantly, the vehicle controller may already know the status of the presence or absence of a trailer before operation of the vehicle is started. In such cases, the vehicle can bypass step 506 and move directly to the appropriate branch (e.g., step 508 to step 512 or steps 514 to 516). If the trailer is present, the vehicle controller than determines surface conditions at step 508. At step 510, based on the determination of step 508, the vehicle controller determines the operation of the third brake valve. That is, how much pressure should be applied to the trailer brakes and how far in advance should the pressure be applied to the trailer brakes in advance of the tractor brakes. Once these determinations are made, the braking system is actuated at step 510 and the vehicle then comes to a stop. If no trailer is present, the vehicle controller may determine surface conditions at step 514 and determine the appropriate braking pressure to application. Then, at step 516, the braking system is actuated to applying braking to the tractor brakes.

As described herein, the braking systems 100, 200 may be considered to have two valve systems: a first valve system comprising the first brake valve 124, the second brake valve 126, and the tractor protection valve 120, and a second valve system comprising the third brake valve 128.

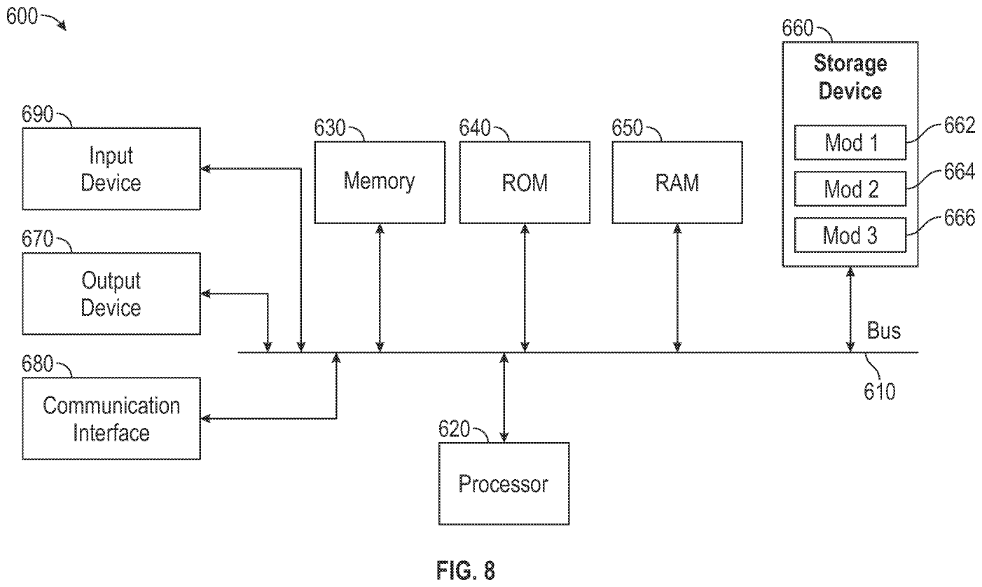

In order to effectuate the controls and methods previously described the computers and/or controllers of FIGS. 1 to 7 may be computers as described with respect to FIG. 8. With reference to FIG. 8, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art, such as, for example, a display. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Aspects of the present disclosure may be appreciated from the following clauses.

A brake system for an autonomous tractor-trailer includes a first brake valve configured to allow pressurized air to flow to first tractor brakes and trailer brakes, a second brake valve configured to allow pressurized air to flow to second tractor brakes, and a third brake valve configured to allow pressurized air to flow to the trailer brakes, wherein the third brake valve is configured to be actuated before the first brake valve and the second brake valve.

The brake system of the preceding clause, further including a controller configured to actuate the first brake valve, the second brake valve, and the third brake valve.

The brake system of any preceding clause, wherein the controller is configured to control a timing of actuation of the third brake valve and a pressure of the air flow through the third brake valve to the trailer brakes.

The brake system of any preceding clause, further including a tractor protection valve configured to prevent passage of pressurized air to the trailer brakes when no trailer is coupled to the tractor.

The brake system of any preceding clause, wherein the third brake valve is downstream of the tractor protection valve.

The brake system of any preceding clause, wherein the third brake valve is upstream of the tractor protection valve.

The brake system of any preceding clause, further including a sensor system configured to detect a fault in the first brake valve, the second brake valve, and the third brake valve.

The brake system of any preceding clause, wherein the sensor system includes at least three pressure sensors at each of the first brake valve, the second brake valve, and the third brake valve.

The brake system of any preceding clause, wherein the sensor system is configured to operate as a voting system to determine a pressure at the respective first brake valve, second brake valve, and third brake valve.

The brake system of any preceding clause, further including a treadle valve, wherein the treadle valve and the first brake valve are each configured to allow pressurized air to flow to the first tractor brakes.

The brake system of any preceding clause, further including a treadle valve, wherein the treadle valve and the second brake valve are each configured to allow pressurized air to flow to the second tractor brakes.

The brake system of any preceding clause, further including a treadle valve, wherein the treadle valve and the third brake valve are each configured to allow pressurized air to flow to the second tractor brakes.

The brake system of any preceding clause, further including a reservoir configured to supply pressure to the third brake valve; and a pressure line connected directly between the reservoir and the third brake valve such that the third brake valve is the only valve coupled to the pressure line.

An autonomous tractor-trailing including the brake system of any preceding clause.

An autonomous tractor-trailer including a tractor, a trailer coupled to the tractor, and a brake system configured to stop the tractor and the trailer. The brake system including a first valve system configured to apply brakes to the tractor and the trailer, and a second valve system configured to apply brakes to the trailer, wherein the second valve system is actuated prior to the first valve system.

The autonomous tractor-trailer of any preceding clause, wherein the first valve system includes a first brake valve configured to allow pressurized air to flow to a first set of tractor brakes; a second brake valve configured to allow pressurized air to flow to a second set of tractor brakes; and a tractor protection valve configured to allow pressurized air to flow to flow to trailer brakes.

The autonomous tractor-trailer of any preceding clause, wherein the second valve system includes a third brake valve on a dedicated pressure line separate from the first brake valve and the second brake valve.

The autonomous tractor-trailer of any preceding clause, further including a controller configured to actuate the first valve system and the second valve system, wherein the controller is configured to control a timing of actuation of the second valve system and a pressure of an air flow through the second valve system.

The autonomous tractor-trailer of any preceding clause, the first valve system further including a tractor protection valve configured to prevent passage of pressurized air to trailer brakes when no trailer is coupled to the tractor.

The autonomous tractor-trailer of any preceding clause, wherein the second valve system is downstream of the tractor protection valve.

The autonomous tractor-trailer of any preceding clause, wherein the second valve system is upstream of the tractor protection valve.

The autonomous tractor-trailer of any preceding clause, further including a sensor system configured to detect a fault in the first valve system and the second valve system.

The autonomous tractor-trailer of any preceding clause, wherein the sensor system includes at least three pressure sensors at each of the first valve system and the second valve system.

The autonomous tractor-trailer of any preceding clause, wherein the sensor system is configured to operate as a voting system to determine a pressure at the respective first valve system and the second valve system.

A method of braking a tractor-trailer with the brake system of any preceding clause.

A method of braking the autonomous tractor-trailer of any preceding clause.

A method of braking a tractor-trailer driven autonomously, the method including sensing, autonomously, a braking event, the braking event being indicative of a requirement for braking the tractor-trailer and actuating a trailer brake valve of a trailer of the tractor-trailer to apply trailer brakes in response to the sensing of the braking event, wherein the trailer brakes are applied prior to actuating a tractor brake valve of a tractor of the tractor-trailer to apply tractor brakes and to apply trailer brakes.

The method of any preceding clause, wherein the tractor brake valve includes a first brake valve associated with forward brakes of the tractor, a second brake valve associated with rear brakes of the tractor, and a tractor protection valve associated with the trailer brakes.

The method of any preceding clause, wherein the trailer brakes are actuated prior to each of the first brake valve and the second brake valve.

The method of any preceding clause, wherein the trailer brake valve is downstream of the tractor protection valve.

The method of any preceding clause, wherein the trailer brake valve is upstream of the tractor protection valve.

The method of any preceding clause, wherein actuating the trailer brake valve is based on a surface condition of a road.

The method of any preceding clause, wherein the surface condition is available traction on the road.

The method of any preceding clause, further including adjusting a time period that the trailer brake valve is actuated prior to the tractor brake valve based on the surface condition.

The method of any preceding clause, further including adjusting a pressure through the trailer brake valve based on the surface condition.

The method of any preceding clause, further including detecting a braking pressure of each of the trailer brake valve and the tractor brake valve.

The method of any preceding clause, further including determining an accurate braking pressure of the trailer brake valve and the tractor brake valve by employing a voting system for detecting the braking pressure at each of the trailer brake valve and the tractor brake valve.

The method of any preceding clause, further including detecting a fault in the tractor brake valve or the trailer brake valve.

The method of any preceding clause, wherein sensing the braking event further includes detecting surface conditions and determining a braking operation based on the detected surface conditions.

A method of braking a tractor-trailer includes determining surface conditions of a road, determining, based on the surface condition, a braking operation of a trailer brake valve, and actuating the braking operation of the trailer brake valve prior to actuating a tractor brake valve.

The method of any preceding clause, wherein determining the braking operation of the trailer brake valve includes one or both of: determining a time period of actuation of the trailer brake valve prior to actuation of the tractor brake valve or determining a pressure of actuation of the trailer brake valve.

The method of any preceding clause, wherein the tractor brake valve includes a first brake valve associated with forward brakes of a tractor or the tractor-trailer, a second brake valve associated with rear brakes of the tractor, and a tractor protection valve associated with trailer brakes.

The method of any preceding clause, wherein the trailer brakes are actuated prior to each of the first brake valve, the second brake valve, and the tractor protection valve.

The method of any preceding clause, wherein the trailer brake valve is downstream of the tractor protection valve.

The method of any preceding clause, wherein the trailer brake valve is upstream of the tractor protection valve.

The method of any preceding clause, wherein the surface condition is available traction on the road.

The method of any preceding clause, further including detecting a braking pressure of each of the trailer brake valve and the tractor brake valve.

The method of any preceding clause, further including determining a reliable braking pressure of the trailer brake valve and the tractor brake valve by employing a voting system for detecting the braking pressure at each of the trailer brake valve and the tractor brake valve.

The method of any preceding clause, further including detecting a fault in the tractor brake valve or the trailer brake valve.

The method of any preceding clause, the method further including determining that a trailer is coupled to the tractor, wherein the braking operation includes actuating the trailer brake valve.

The method of any preceding clause, the method further including determining that a trailer is not coupled to the tractor, wherein the braking operation includes not actuating the trailer brake valve

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A brake system for an autonomous tractor-trailer, the brake system comprising:
a first brake valve configured to allow pressurized air to flow to first tractor brakes and trailer brakes;
a second brake valve configured to allow pressurized air to flow to second tractor brakes; and
a third brake valve configured to allow pressurized air to flow to the trailer brakes, wherein the third brake valve is configured to be actuated before the first brake valve and the second brake valve.

2. The brake system of claim 1, further comprising a controller configured to actuate the first brake valve, the second brake valve, and the third brake valve.

3. The brake system of claim 2, wherein the controller is configured to control a timing of actuation of the third brake valve and a pressure of the air flow through the third brake valve to the trailer brakes.

4. The brake system of claim 1, further comprising a tractor protection valve configured to prevent passage of pressurized air to the trailer brakes when no trailer is coupled to the tractor.

5. The brake system of claim 4, wherein the third brake valve is downstream of the tractor protection valve.

6. The brake system of claim 4, wherein the third brake valve is upstream of the tractor protection valve.

7. The brake system of claim 1, further comprising a sensor system configured to detect a fault in the first brake valve, the second brake valve, and the third brake valve.

8. The brake system of claim 7, wherein the sensor system comprises at least three pressure sensors at each of the first brake valve, the second brake valve, and the third brake valve.

9. The brake system of claim 7, wherein the sensor system is configured to operate as a voting system to determine a pressure at the respective first brake valve, second brake valve, and third brake valve.

10. The brake system of claim 1, further comprising a treadle valve, wherein the treadle valve and the first brake valve are each configured to allow pressurized air to flow to the first tractor brakes.

11. The brake system of claim 1, further comprising a treadle valve, wherein the treadle valve and the second brake valve are each configured to allow pressurized air to flow to the second tractor brakes.

12. The brake system of claim 1, further comprising a treadle valve, wherein the treadle valve and the third brake valve are each configured to allow pressurized air to flow to the second tractor brakes.

13. The brake system of claim 1, further comprising a reservoir configured to supply pressure to the third brake valve; and a pressure line connected directly between the reservoir and the third brake valve such that the third brake valve is the only valve coupled to the pressure line.

14. An autonomous tractor-trailer comprising:
a tractor;
a trailer coupled to the tractor; and
a brake system configured to stop the tractor and the trailer, the brake system comprising:
a first valve system configured to apply brakes to the tractor and the trailer; and
a second valve system configured to apply brakes to the trailer, wherein the second valve system is actuated prior to the first valve system.

15. The autonomous tractor-trailer of claim 14, wherein the first valve system comprises a first brake valve configured to allow pressurized air to flow to a first set of tractor brakes; a second brake valve configured to allow pressurized air to flow to a second set of tractor brakes; and a tractor protection valve configured to allow pressurized air to flow to flow to trailer brakes.

16. The autonomous tractor-trailer of claim 15, wherein the second valve system comprises a third brake valve on a dedicated pressure line separate from the first brake valve and the second brake valve.

17. The autonomous tractor-trailer of claim 14, further comprising a controller configured to actuate the first valve system and the second valve system, wherein the controller is configured to control a timing of actuation of the second valve system and a pressure of an air flow through the second valve system.

18. The autonomous tractor-trailer of claim 14, the first valve system further comprising a tractor protection valve configured to prevent passage of pressurized air to trailer brakes when no trailer is coupled to the tractor.

19. The autonomous tractor-trailer of claim 18, wherein the second valve system is downstream of the tractor protection valve.

20. The autonomous tractor-trailer of claim 18, wherein the second valve system is upstream of the tractor protection valve.

21. The autonomous tractor-trailer of claim 14, further comprising a sensor system configured to detect a fault in the first valve system and the second valve system.

22. The autonomous tractor-trailer of claim 21, wherein the sensor system comprises at least three pressure sensors at each of the first valve system and the second valve system.

23. The autonomous tractor-trailer of claim 21, wherein the sensor system is configured to operate as a voting system to determine a pressure at the respective first valve system and the second valve system.
